(19) United States
(12) Patent Application Publication
(10) Pub. No.: US 2007/0055016 A1
(43) Pub. Date: Mar. 8, 2007

(54) Aqueous, two-component polyurethane compositions containing OH-functional polydimethylsiloxanes

(75) Inventors: Meike Niesten, Koln (DE); Jorg Tillack, Bergisch Gladbach (DE); Michael Struwe, Langenfeld (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/512,948

(22) Filed: Aug. 30, 2006

(30) Foreign Application Priority Data
Sep. 3, 2005 (DE) 102005041951.8

(51) Int. Cl. C08L 29/00; C08L 83/06

(52) U.S. Cl. 525/100; 525/479

(57) ABSTRACT

The present invention relates to aqueous, two-component compositions containing
A) hydroxyl-containing polydimethylsiloxanes having number average molecular weights of 400 to 3000 and an average OH functionality of ≧1.8, and containing at least one structural unit of formula I) 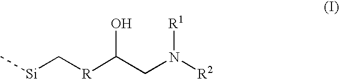 wherein
R is an aliphatic, linear or branched C₁ to C₂₀ radical,
R¹ is a linear or branched hydroxyalkyl radical having 2 to 10 carbon atoms and
R² is either hydrogen or a linear or branched hydroxyalkyl radical having 2 to 10 carbon atoms,
B) addition polymers containing hydroxyl groups and having a number average molecular weight Mₙ of 500 to 50,000, a hydroxyl number of 16.5 to 264 mg KOH/g solid resin, an acid number of 0 to 150 mg KOH/g solid resin and a chemically bound carboxylate and/or sulphonate group content of 5 to 417 milliequivalents per 100 g of polymer solids, and C) polyisocyanates. The present invention also relates to coatings, adhesives or sealants obtained from these compositions.

### BACKGROUND OF THE INVENTION

1. Field of the Invention

The present invention relates to aqueous, two-component, polyurethane compositions containing hydroxyl-functional polydimethylsiloxanes and to their use for preparing coatings, adhesives or sealants.

2. Description of Related Art

Two-component coating compositions containing, as binder, a polyisocyanate component in combination with an isocyanate-reactive component, in particular a polyhydroxyl component, are known. They are suitable for producing high-grade coatings, which can be made hard, elastic, abrasion resistant and solvent resistant. In view of increasingly stringent legislation governing the permitted amounts of volatile organic components in coating compositions, for example, demand for aqueous systems is increasing. Aqueous two-component coating compositions have been known for many years and are described, e.g., in EP-A 0 358979. The modification of 2K PU paint systems with polydimethylsiloxanes (PDMS) is known. The high surface tension of PDMS produces specific properties, such as good surface wetting, slip resistance and an easy-to-clean surface (Reusmann in Farbe und Lack, 105, volume 8/99, pages 40-47; Adams in Paintindia, October 1996, pages 31-37).

In order to ensure effective incorporation of PDMS and to substantially prevent migration of the PDMS, organofanctional PDMS types, such as alkyleneamine- or alkylenehydroxyl-functional PDMS derivatives, are often used. Paint systems of this kind are described for example in WO91/18954, EP-A 0 329 260 or U.S. Pat. No. 4,774,278.

The amine-functional PDMS types, however, have the disadvantage that the pot life of polyurethane systems based on them is extremely abbreviated, due to the high propensity to form ureas.

Although the known hydroxyl-functional PDMS types give improved pot lives, they generally exhibit incompatibilities with the polyisocyanate component, meaning that homogeneous films cannot be produced and that crosslinking is incomplete. As a result there is free, unbound PDMS in the paint, which migrates over time from the coating and leads to a deterioration in the coating's properties.

U.S. Pat. No. 6,475,568 describes the use of copolyols obtained by reaction of epoxy-functional PDMS oligomers and primary or secondary amines as an additive for cosmetics products or fabric softeners. The use of these compounds for preparing 2K PU binders for paints and coatings is not described.

WO 2004/022619 describes the use of chain extenders for polyurea systems which are obtained by reacting epoxy-functional PDMS with amines. The reaction of epoxy-functional PDMS with hydroxylamines to form the corresponding OH-functional compounds is not described.

It has now been found that the disadvantages of the prior art can be avoided by using specific hydroxyl-containing polydimethylsiloxanes as part of the isocyanate-reactive binder component in combination with specific polyacrylate polyols.

### SUMMARY OF THE INVENTION

The present invention relates to aqueous, two-component compositions containing
A) hydroxyl-containing polydimethylsiloxanes having number average molecular weights of 400 to 3000 and an average OH functionality of ≧1.8, and containing at least one structural unit of formula I) 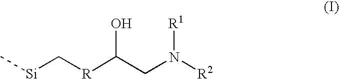
   wherein
   R is an aliphatic, linear or branched Cl to C₂₀ radical,
   R¹ is a linear or branched hydroxyalkyl radical having 2 to 10 carbon atoms and
   R² is either hydrogen or a linear or branched hydroxyalkyl radical having 2 to 10 carbon atoms,
B) addition polymers containing hydroxyl groups and having a number average molecular weight Mₙ of 500 to 50,000, a hydroxyl number of 16.5 to 264 mg KOH/g solid resin, an acid number of 0 to 150 mg KOH/g solid resin and a chemically bound carboxylate and/or sulphonate group content of 5 to 417 milliequivalents per 100 g of polymer solids, and
C) polyisocyanates.

The present invention also relates to coatings, adhesives or sealants obtained from these compositions.

### DETAILED DESCRIPTION OF THE INVENTION

Component A) is preferably used in an amount of 0.01% to 20% by weight, more preferably 0.1% to 10%, and component B) is preferably used in an amount of 80% to 99.99% by weight, more preferably 90% to 99.90% by weight, wherein these percentages are based on the total weight of components A) and B).

Preferably, the equivalent ratio of NCO groups in component C) to OH-functional groups in components A) and B) is 0.5:1 to 5.0:1, more preferably 0.8:1 to 2:1.

Preferably, hydroxyl-containing polydimethylsiloxanes A) have an average OH functionality of 1.9 to 6. These hydroxyl-containing polydimethylsiloxanes are obtained by reacting the corresponding epoxy-functional polydimethylsiloxanes with hydroxylamines, preferably at an equivalent ratio of epoxy groups to NH groups of 1:1. The epoxy-functional polydimethylsiloxanes preferably contain 1 to 4 epoxy groups per molecule. Additionally, they preferably have number average molecular weights of 150 to 2800, more preferably 250 to 2000.

More preferably the epoxy-functional polydimethylsiloxanes are α,ω-epoxy-dimethylsiloxanes which have the preceding molecular weights, have an average of 2 epoxy groups per molecule, and correspond to formula II) 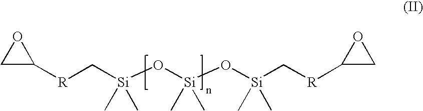
wherein
R is a linear or branched, aliphatic C₁ to C₁₀ radical and
n an integer from 1 to 25.

Products of this kind are available commercially from, for example, GE Bayer Silicones, Leverkusen, Germany, Tego, Essen, Germany or Wacker, Munich, Germany.

The hydroxylamines correspond to formula III) 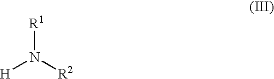
wherein
R¹ is a linear or branched hydroxyalkyl radical having 2 to 10 carbon atoms and
R² is either hydrogen or a linear or branched hydroxyalkyl radical having 2 to carbon atoms.

Preferred hydroxylamines are ethanolamine, propanolamine, diethanolamine and dipropanolamine. Particular preference is given to diethanolamine.

To prepare the modified siloxanes of component A) the epoxy-functional siloxane is introduced into a vessel, optionally in a solvent, and then reacted with the hydroxylamine or a mixture of two or more hydroxylamines. The reaction temperature is preferably 20 to 150° C. and is carried on until free epoxy groups are no longer detected. The hydroxyl-containing polydimethylsiloxanes of component A) preferably have number average molecular weights of 250 to 2250.

Component B) comprises addition polymers which contain hydroxyl groups and sulphonate and/or carboxylate groups. The expression “sulphonate and/or carboxylate groups” embraces not only the deprotonated anionic sulphonate and carboxylate groups, respectively, but also the corresponding sulphonic acid and carboxylic acid functions.

These addition polymers are obtained by free-radical polymerization of suitable olefinically unsaturated monomers and have a number average molecular weight Mₙ, determined by gel permeation chromatography, of 500 to 50,000, preferably 1000 to 10,000; a hydroxyl number of 16.5 to 264, preferably 33 to 165 mg KOH/g solid resin; an acid number (based on the non-neutralized sulphonic acid and/or carboxyl groups) of 0 to 150, preferably 0 to 100 mg KOH/g solid resin; and a sulphonate and/or carboxylate group content of 5 to 417, preferably 24 to 278 milliequivalents per 100 g solids. Preferred anionic hydrophilic groups are the carboxylate groups.

The polymer resins B), which are employed for the preparation of the aqueous compositions of the invention, are in the form of aqueous solutions and/or dispersions having a resin solids content of preferably 10% to 50%, more preferably 20% to 40% by weight; a viscosity of 10 to 10⁵, preferably 100 to 10,000 mPa.s/23° C.; and pH values of 5 to 10, preferably 6 to 9.

Depending on the molecular weight of the polymers and the amount of ionic groups and/or free acid groups present therein, especially carboxyl groups, the aqueous systems containing the polymers are true dispersions, colloidally disperse or molecularly disperse dispersions, but in general are what are called “partial dispersions”, i.e. aqueous systems which are partly molecularly disperse and partly colloidally disperse.

The hydroxyl-containing polymers are prepared by the conventional copolymerization of olefinically unsaturated monomers. The unsaturated monomers include hydroxyl-containing monomers, acid-containing monomers, and other monomers that do not contain either hydroxyl or acid groups. After the copolymerization reaction the acid groups present are at least partly neutralized.

The purpose of including monomers containing acid groups is to incorporate carboxyl groups and/or sulphonic acid groups into the copolymers. Their hydrophilicity ensures that the polymers are soluble or dispersible in water, particularly after the acid groups have been at least partially neutralized. The amount of the “acidic” comonomers included, and the degree of neutralization of the “acidic” polymers initially obtained, correspond to the figures given above for the acid number and for the sulphonate and/or carboxylate group content. In general the “acidic” comonomers are employed in amounts of 1% to 30%, preferably 5% to 20% by weight, based on the total weight of the monomers employed.

Suitable “acidic” monomers include all olefinically unsaturated, polymerizable compounds which contain at least one carboxyl group and/or sulphonic acid group. The olefinically unsaturated monocarboxylic or dicarboxylic acids have a molecular weight of 72 to 207 g/mol and include acrylic acid, methacrylic acid, maleic acid and itaconic acid. Also suitable are olefinically unsaturated compounds containing sulphonic acid groups, such as 2-acrylamido-2-methylpropanesulphonic acid, or mixtures of olefinically unsaturated acids.

The hydroxyl-containing monomers are used in amounts sufficient to provide the abovementioned polymer hydroxyl numbers, which preferably correspond to a polymer hydroxyl group content of 0.5% to 8%, more preferably 1% to 5% by weight. The hydroxyl-functional monomers are preferably included in amounts of 3% to 75%, more preferably 6% to 47% by weight, based on the total weight of monomers employed.

In addition it is necessary to ensure that, within the ranges specified, the amount of the hydroxyl-functional monomers is selected to result in copolymers which contain an average of at least two hydroxyl groups per molecule.

Preferred hydroxyl-containing monomers are hydroxyalkyl esters of acrylic acid or methacrylic acid, preferably having 2 to 4 carbon atoms in the alkyl radical. Examples include 2-hydroxyethyl acrylate or methacrylate, 2- or 3-hydroxypropyl acrylate or methacrylate, the isomeric hydroxybutyl acrylates or methacrylates, and mixtures thereof.

The third group of olefinically unsaturated monomers, which are generally included when preparing the copolymers, are olefinically unsaturated compounds which contain neither acid groups nor hydroxyl groups, such as the esters of acrylic acid or methacrylic acid having 1 to 18, preferably 1 to 8 carbon atoms in the alcohol residue. Examples include methyl acrylate, ethyl acrylate, isopropyl acrylate, n-propyl acrylate, n-butyl acrylate, 2-ethylhexyl acrylate, n-stearyl acrylate, the methacrylates corresponding to these acrylates, styrene, alkyl-substituted styrenes, acrylonitrile, methacrylonitrile, vinyl acetate, vinyl stearate, and mixtures thereof. Other monomers containing epoxide groups, such as glycidyl acrylate or methacrylate, or monomers such as N-methoxy-methylacrylamide or -methacrylamide, can be included in small amounts.

The third group of monomers without acid and hydroxyl groups are preferably included in amounts of up to 90% by weight, more preferably 40% to 80% by weight, based on the total weight of the monomers employed.

The addition polymers can be prepared by free radical polymerization in accordance with known methods. Preparation of the polymers takes place preferably in organic solution. Continuous or discontinuous polymerization methods are possible. The discontinuous methods include the batch method and the feed method, of which the latter is preferred. In the feed method the solvent is introduced as an initial charge, alone or together with part of the monomer mixture. This initial charge is heated to the polymerization temperature and, when monomer has been charged, free radical polymerization is initiated. The remaining monomer mixture is metered in together with an initiator mixture in the course of 1 to 10 hours, preferably 3 to 6 hours. An option thereafter is to reactivate the polymerization mixture, in order to carry out the polymerization up to a conversion of at least 99%.

Suitable solvents include aromatics such as benzene, toluene, xylene and chlorobenzene; esters such as ethyl acetate, butyl acetate, methyl glycol acetate, ethyl glycol acetate and methoxypropyl acetate; ethers such as butyl glycol, tetrahydrofuran, dioxane and ethyl glycol ether; ketones such as acetone and methyl ethyl ketone; and halogenated solvents such as methylene chloride and trichloromonofluoroethane.

The free radically-initiated polymerization can be triggered by initiators whose free radical decomposition half-lives at 80 to 180° C. are between 0.01 and 400 minutes. In general the copolymerization reaction takes place within the stated temperature range, preferably between 100 and 160° C., under a pressure of 10³ to 2×10⁴ mbar. The precise polymerization temperature is governed by the identity of the initiator. The initiators are employed in amounts of 0.05% to 6% by weight, based on the total amount of monomers.

Examples of suitable initiators include aliphatic azo compounds such as azoisobutyronitrile and peroxides such as dibenzoyl peroxide, tert-butyl perpivalate, tert-butyl per-2-ethylhexanoate, tert-butyl perbenzoate, tert-butyl hydroperoxide, di-tert-butyl peroxide, cumene hydroperoxide and dicyclohexyl and dibenzyl peroxydicarbonate.

To regulate the molecular weight of the polymers it is possible to use known regulators such as n-dodecyl mercaptan, diisopropylxanthogen disulphide, di(methylenetrimethylolpropane)xanthogen disulphide and thioglycol. They are added in amounts of not more than 3% by weight, based on the weight of the monomer mixture.

When the polymerization is over the copolymers are converted into the form of an aqueous solution or dispersion. For this purpose the organic polymer solution is introduced into an aqueous phase, which usually has been preheated, and at the same time the organic solvent is removed by distillation, generally under an applied vacuum. In order to achieve effective solubility or dispersibility in water, it is generally necessary to add a neutralizing agent to the aqueous phase, such as inorganic bases, ammonia or amines. Examples include inorganic bases such as sodium hydroxide and potassium hydroxide; ammonia; and amines such as trimethylamine, triethylamine and dimethylethanolamine.

The neutralizing agents can be used in excess and substoichiometric quantities to obtain the aforementioned sulphonate and/or carboxylate group contents, especially carboxylate group contents, and the aforementioned acid numbers. In the case of complete neutralization of the acid groups present the resulting acid number is zero, while the sulphonate and/or carboxylate group content corresponds to the original sulphonic acid group and/or carboxyl group content. In the case of partial neutralization, the sulphonate and/or carboxylate group contents correspond to the amount of neutralizing agent employed.

When using a stoichiometric excess of neutralizing agent, a distinct increase in viscosity is possible due to the polyelectrolyte character of the polymers. The aqueous solutions or dispersions obtained possess the abovementioned concentrations and viscosities and preferably have a residual solvent content of below 5% by weight, more preferably below 2% by weight. By means of azeotropic distillation it is possible to remove solvents, even those whose boiling points are higher than that of water, virtually without residue.

Suitable polyisocyanates C) are organic polyisocyanates having an average NCO functionality of at least 2 and a number average molecular weight of at least 140. Examples include i) unmodified, monomeric organic polyisocyanates having a number average molecular weight of 140 to 300, ii) lacquer polyisocyanates having a number average molecular weight of 300 to 1000, and iii) NCO prepolymers containing urethane groups and having a number average molecular weights of ≧1000, or mixtures of i) to iii).

Examples of polyisocyanates i) include 1,4-diisocyanatobutane, 1,6-diisocyanatohexane (HDI), 1,5-diisocyanato-2,2-dimethylpentane, 2,2,4- and 2,4,4-trimethyl-1,6-diisocyanatohexane, 1-isocyanato-3,3,5-trimethyl-5-isocyanatomethylcyclohexane (IPDI), 1-isocyanato-1-methyl-4-(3)-isocyanatomethylcyclohexane, bis(4-isocyanatocyclohexyl)methane, 1,10-diisocyanatodecane, 1,12-diisocyanatododecane, cyclohexane 1,3- and 1,4-diisocyanate, xylylene diisocyanate isomers, triisocyanatononane (TIN), 2,4-diisocyanatotoluene or mixtures with 2,6-diisocyanatotoluene, preferably mixtures with up to 35% by weight of 2,6-diisocyanatotoluene, 2,2′-, 2,4′-, 4,4′-, diisocyanatodiphenylmethane, polyisocyanate mixtures of the diphenylmethane series, and mixtures thereof. Preferred are the polyisocyanates of the diphenylmethane series, more preferably in the form of isomer mixtures.

Polyisocyanates of group ii) are the known lacquer polyisocyanates, which are compounds or mixtures of compounds obtained by the conventional oligomerization reaction of the monomeric diisocyanates exemplified under i). Examples of suitable oligomerization reactions are carbodiimidization, dimerization, trimerization, biuretization, urea formation, urethanization, allophanatization and/or cyclization with the formation of oxadiazine groups. In an “oligomerization” reaction often two or more of the reactions proceed simultaneously or in succession.

Lacquer polyisocyanates ii) are preferably biuret polyisocyanates, polyisocyanates containing isocyanurate groups, polyisocyanate mixtures containing isocyanurate and uretdione groups, polyisocyanates containing urethane and/or allophanate groups, and polyisocyanate mixtures based on monomeric diisocyanates and containing isocyanurate and allophanate groups.

The preparation of these lacquer polyisocyanates is known and is described for example in DE-A 1595 273, DE-A 3 700 209 and DE-A 3 900 053 or in EP-A-0 330 966, EP-A 0 259 233, EP-A-0 377 177, EP-A-0 496 208, EP-A-0 524 501 or U.S. Pat. No. 4,385,171.

Polyisocyanates iii) are the known prepolymers containing isocyanate groups that are prepared by reacting monomeric diisocyanates i) and/or lacquer polyisocyanates ii) with organic polyhydroxyl compounds having a number average molecular weight of above 300. The lacquer polyisocyanates ii) that contain urethane groups are prepared from low molecular weight polyols having a number average molecular weight of 62 to 300 such as ethylene glycol, propylene glycol, trimethylolpropane, glycerol or mixtures of these alcohols. To the contrary the NCO prepolymers iii) are prepared using polyhydroxyl compounds having, number average molecular weights of above 300, preferably above 500, and more preferably from 500 to 8000. Preferred polyhydroxyl compounds are those having per molecule 2 to 6, preferably 2 to 3, hydroxyl groups such polyether, polyester, polythioether, polycarbonate and polyacrylate polyols and mixtures of these polyols.

It is also possible to prepare NCO prepolymers iii) from mixtures of high molecular weight polyols and low molecular weight polyols, resulting in mixtures of low molecular weight lacquer polyisocyanates ii) containing urethane groups and NCO prepolymers iii), which are also suitable as starting component (C) according to the invention.

NCO prepolymers iii) or mixtures thereof with lacquer polyisocyanates ii) are prepared by reacting polyisocyanates i) or lacquer polyisocyanates ii) with the high molecular weight polyhydroxyl compounds or mixtures thereof with low molecular weight polyhydroxyl compounds at an NCO/OH equivalent ratio of 1.1:1 to 40:1, preferably 2:1 to 25:1, to form urethane groups. Optionally, when using an excess of distillable starting diisocyanate, this excess can be removed by distillation following the reaction to provide monomer-free NCO prepolymers. When they are not removed by distillation, mixtures of starting diisocyanates i) and NCO prepolymers iii) are obtained, which may also be used as component A).

Low-viscosity, hydrophilic polyisocyanates containing free isocyanate groups and prepared from aliphatic, cycloaliphatic, araliphatic and/or aromatic isocyanates, preferably aliphatic or cycloaliphatic isocyanates, can also be used.

Hydrophilic polyisocyanates can be prepared, for example, by reacting polyisocyanates with substoichiometric amounts of monohydric, hydrophilic polyether alcohols. The preparation of these hydrophilic polyisocyanates is described, for example, in EP-A 0 540 985, p. 3, 1. 55-p. 4 1. 5. Also suitable are the polyisocyanates containing allophanate groups that are described in EP-A-959087, p. 3 11. 39-51, which are prepared by reacting low monomer content polyisocyanates with polyethylene oxide polyether alcohols under allophanatization conditions. Also suitable are the triisocyanatononane-based, water-dispersible polyisocyanate mixtures described in DE-A 100 078 21, p. 2 1. 66-p. 3 1. 5, and also hydrophilic polyisocyanates containing ionic groups (sulphonate groups, phosphonate groups) described for example in DE 10024624, p 3 1. 13-33. Also suitable hydrophilic polyisocyanates rendered hydrophilic by blending with known external emulsifiers.

Preferred hydrophilic polyisocyanates C) are polyisocyanates containing sulphonate groups. These sulphonate-functional polyisocyanates preferably have an average isocyanate functionality of at least 1.8, an isocyanate group content (calculated as NCO; molecular weight=42) of 4.0% to 26.0% by weight, a bound sulphonic acid and sulphonate group content (calculated as SO₃-; molecular weight=80) of 0.1% to 7.7% by weight, and an amount of ethylene oxide units bound within polyether chains (calculated as C₂H₂O; molecular weight=44) of 0 to 19.5% by weight, based on the underlying polyether. If the polyisocyanates contain polyether chains, these chains preferably contain on average 5 to 35 ethylene oxide units.

The counterion to the sulphonate groups is preferably an ammonium ion formed from tertiary amines by protonation. The equivalent ratio of the sum of sulphonic acid groups and sulphonate groups to the sum of tertiary amine and the protonated ammonium ion derived therefrom is typically 0.2 to 2.0.

Examples of the tertiary amines are monoamines such as trimethylamine, triethylamine, tripropylamine, tributylamine, dimethylcyclohexylamine, N-methylmorpholine, N-ethyl-morpholine, N-methylpiperidine and N-ethyl-piperidine; and tertiary diamines such as 1,3-bis(dimethylamino)propane, 1,4-bis(dimethylamino)butane and N,N′-dimethylpiperazine. Suitable neutralizing agents, although less preferred, are tertiary amines which also carry groups that are isocyanate-reactive. Examples include alkanolamines such as dimethyl-ethanol-amine, methyldiethanolamine and triethanolamine. Preferred is dimethylcyclo-hexylamine.

The preparation of these modified polyisocyanates is described in detail in WO-A 01-88006.

It is also possible to use blocked polyisocyanates as component C). Preferably, however, unblocked polyisocyanates are used. Preferred polyisocyanates C) are hydrophilic polyisocyanates.

If necessary, the polyisocyanates can be employed as a blend with small amounts of inert solvents to lower the viscosity to a level within the stated ranges. The maximum amount of these solvents is calculated such that the resulting coating compositions of the invention do not contain more than 20% by weight of solvent, based on the amount of water, and including, where appropriate, the solvent present in the polymer dispersions or polymer solutions. Solvents suitable as adjuvants for the polyisocyanates include aromatic hydrocarbons such as “solvent naphtha,” for example, or the solvents exemplified above.

The invention also provides a process for preparing a coating material of this kind, in which the polyisocyanate component C) is emulsified in an aqueous solution or dispersion of components A) and B), the proportions of components A) to C) being calculated such as to result in an NCO/OH equivalent ratio of 0.5:1 to 5: 1, preferably 0.8:1 to 2:1.

Prior to the addition of polyisocyanate component C) it is possible to incorporate the known additives of coatings technology into polymer component A), i.e., the dispersion or solution of the polymers. These additives include internal release agents, fillers, dyes, pigments, flame retardants, hydrolysis inhibitors, microbiocides, flow control assistants, solvents, antioxidants, defoamers, and dispersing aids for pigment dispersions.

The coating compositions of the invention are suitable for virtually all fields of use in which solvent-borne, solvent-free or other kinds of aqueous paint and coating systems with a heightened profile of properties are presently used. Examples include the coating of virtually all mineral building material surfaces such as lime-bound and/or cement-bound renders, surfaces containing plaster, fiber-cement building materials and concrete; the coating and sealing of wood and wood materials such as chipboard, wood fiberboard and paper; the coating of metallic surfaces; the coating of asphaltic or bituminous road coverings; and the coating and sealing of various plastics surfaces.

The invention is further illustrated but is not intended to be limited by the following examples in which all parts and percentages are by weight unless otherwise specified.

### EXAMPLES

The dynamic viscosities were determined at 23° C. using a rotational viscometer (ViscoTester® 550, Thermo Haake GmbH, D-76227 Karlsruhe).

The OH number was determined in accordance with DIN 53240 P. 2

The epoxide group content was determined in accordance with DIN 16945, and is based on a molar weight of 42 g/mol.

The gloss was measured in accordance with DIN 67530.

Haze was determined in accordance with DIN 67530.

The König pendulum hardness was determined in accordance with DIN 53157 after storage for 7 days at room temperature.

The easy-to-clean properties were determined by applying a Lumocolor Permanent Marker 350 (Staedler, Nuremberg, DE) in red, leaving it to act for 1 minute. Attempts were then made to remove the mark with with a dry cellulosic paper cloth and with a cellulosic paper cloth wetted in ethanol.

Starting Materials

MPA: Methoxypropyl acetate

DBTL: Dibutyltin dilaurate

Surfynol 104 BC (50% in butane glycol): 2,4,7,9-tetramethyl-5-decyne-4,7-diol, Lanxess, Leverkusen, DE

Borchigel PW 25 (25% in propane glycol/water): nonionic thickener based on polyurethane, Bayer Material Science AG, Leverkusen, DE

Baysilone VP AI 3468 (10% in butane glycol): polyether polysiloxane surface additive, Borchers GmbH, Langenfeld DE

Solvent naphtha 100: aromatics-containing solvent.

Preparation of Polvol I:

770 g of an epoxide of the formula 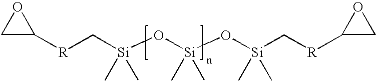
which has a number average molecular weight of 700 and wherein R is CH₂, were introduced into a vessel and 231 g of diethanolamine were added. The mixture was subsequently stirred at 100° C. for 2 hours. The product was free of epoxy groups, and had an OH number of 370 mg KOH/g and a viscosity at 23° C. of 2900 mPa.s.
Comparative polyol I:

For comparison, polyols of the formula

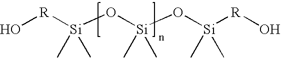

were used. Their properties are summarized in the table below:

| | Baysilone | Baysilone | | |
|---|---|---|---|---|
| | OF/OH502 | OF/OH 502 | Wacker | Tegomer |
| Comparative polyols | 6% | 3% | IM11 | HSi 2311 |
| Manufacturer | GE Bayer | GE Bayer | Wacker | Tego |
| | Silicones | Silicones | | |
| R = | CH₂ | CH₂ | CH₂CH(CH₃) | (CH₂)₃ |
| Viscosity at 25° C. (mPa · s) | 20-50 | 20-50 | 20-50 | 20-50 |
| OH number (mg KOH/g) | 198 | 99 | 96 | 36 |
| Molecular weight (g/mol) | 566 | 1133 | 1172 | 2946 |

Polyol II: water-thinnable, OH-functional polyacrylate dispersion, 45% by weight in water/solvent naphtha 100/Dowanol PnB, neutralized with dimethylethanolamine/triethanolamine, OH content of 3.9%, OH number 128 mg KOH/g and a viscosity of 2000 mPa.s (Bayhydrol XP 2470, Bayer Material Science AG, Leverkusen, DE).

Polyisocyanate: hydrophilic, aliphatic polyisocyanate prepared from 1,6-hexamethylene diisocyanate and having an NCO content of 20.6% by weight and a viscosity at 23° C. of 5400 mPa.s (Bayhydur XP 2487/1, Bayer Material Science AG, Leverkusen, DE).

Preparation of Coating Composition

The components were admixed as set forth in the table below with known coating additives, catalysts and polyisocyanates, with stirring, then applied to glass using a 50 μm doctor blade, and cured at 100° C. for 60 minutes.

| | Example | | | | | |
|---|---|---|---|---|---|---|
| | 1 | 2 | 3 | 4 | 5 | 6 |
| Polyol I | 1.1 | | | | | |
| Wacker IM 11 | | | 1.1 | | | |
| Tegomer H—Si 2311 | | | | 1.1 | | |
| Baysilone OF/OH 3% | | | | | 1.1 | |
| Baysilone OF/OH 6% | | | | | | 1.1 |
| Polyol II | 45.5 | 47.8 | 45.4 | 45.4 | 45.4 | 45.4 |
| Surfynol 104 BC | 1.3 | 1.3 | 1.3 | 1.3 | 1.3 | 1.1 |
| (50% in BG) | | | | | | |
| Borchigel PW 25 (25% | 0.2 | 0.2 | 0.2 | 0.2 | 0.2 | 1.3 |
| PG/water) | | | | | | |
| Baysilone VP AI 3468 | 1.1 | 1.1 | 1.1 | 1.1 | 1.1 | 0.2 |
| (10% BG) | | | | | | |
| Polyisocyanate | 27.1 | 25.7 | 25.2 | 24.7 | 25.2 | 25.9 |
| Water | 31.8 | 31.8 | 31.8 | 31.8 | 31.8 | 1.1 |
| Pendulum hardness 7 | 198 | 200 | 191 | 188 | 195 | 196 |
| days RT (s) | | | | | | |
| Gloss 20° C. | 87 | 79 | 76 | 82 | 82 | 82 |
| Haze | 17 | 99 | 115 | 60 | 62 | 74 |
| Fog on glass plate | 0 | 0-1 | 3 | 3 | 2-3 | 1-2 |
| Easy-to-clean | | | | | | |
| dry | 1 | 3 | 2 | 2 | 2 | 2 |
| ethanol | 1 | 1 | 1 | 2 | 1 | 2 |

0 = good,
5 = poor; amounts in grams

The inventive composition of Example 1 resulted in clear films having a smooth surface and good easy-to-clean properties. Comparative Example 2 had no silicone component and produced films having a dull surface and poorer easy-to-clean properties when compared with Example 1. Comparative Examples 3 to 6, although containing just as much OH-functional siloxane as in Example 1, nevertheless had poorer easy-to-clean properties than Example 1. Also, the films from Examples 3 and 4 had an oily surface, indicating that the silicone diol was not incorporated in the polyurethane matrix. Comparative Examples 5 and 6 had a dull surface.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous, two-component composition comprising
A) a hydroxyl-containing polydimethylsiloxane having a number average molecular weight of 400 to 3000 and an average OH functionality of ≧1.8, and containing at least one structural unit of formula I) 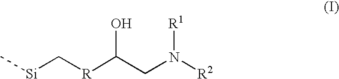
wherein
R is an aliphatic, linear or branched Cl to C₂₀ radical,
R¹ is a linear or branched hydroxyalkyl radical having 2 to 10 carbon atoms and
R² is either hydrogen or a linear or branched hydroxyalkyl radical having 2 to 10 carbon atoms,
B) an addition polymer containing hydroxyl groups and having a number average molecular weight Mₙ of 500 to 50,000, a hydroxyl number of 16.5 to 264 mg KOH/g solid resin, an acid number of 0 to 150 mg KOH/g solid resin and a chemically bound carboxylate and/or sulphonate group content of 5 to 417 milliequivalents per 100 g of polymer solids, and
C) a polyisocyanate.

2. The aqueous composition of claim 1 wherein component A) is used in an amount of 0.01% to 20% by weight and component B) is used in an amount of 80% to 99.99% by weight, wherein these percentages are based on the total weight of components A) and B).

3. The aqueous composition of claim 1 wherein component A) is used in an amount of 0.1% to 10% by weight and component B) is used in an amount of 90% to 99.90% by weight, wherein these percentages are based on the total weight of components A) and B).

4. The aqueous composition of claim 1 wherein the equivalent ratio of NCO groups to OH and/or NH-functional groups is 0.5:1 to 2.0:1.

5. The aqueous composition of claim 2 wherein the equivalent ratio of NCO groups to OH and/or NH-functional groups is 0.5:1 to 2.0:1.

6. The aqueous composition of claim 3 wherein the equivalent ratio of NCO groups to OH and/or NH-functional groups is 0.5:1 to 2.0:1.

7. The aqueous composition of claim 1 wherein radicals R¹ and R² are the same and represent HO—CH₂—CH₂—.

8. The aqueous composition of claim 2 wherein radicals R¹ and R² are the same and represent HO—CH₂—CH₂—.

9. The aqueous composition of claim 3 wherein radicals R¹ and R² are the same and represent HO—CH₂—CH₂—.

10. The aqueous composition of claim 4 wherein radicals R¹ and R² are the same and represent HO—CH₂—CH₂—.

11. The aqueous composition of claim 5 wherein radicals R¹ and R² are the same and represent HO—CH₂—CH₂—.

12. The aqueous composition of claim 6 wherein radicals R¹ and R² are the same and represent HO—CH₂—CH₂—.

13. The aqueous composition of claim 1 wherein the aqueous composition additionally contains a surface-active substance, internal release agent, filler, dye, pigment, flame retardant, hydrolysis inhibitor, microbiocide, flow control assistant, solvent or antioxidant.

14. A coating, adhesive or sealant obtained from the aqueous composition of claim 1.

15. A substrate that has been coated, bonded or sealed with the aqueous composition of claim 1.
